(19) United States
(12) Patent Application Publication
(10) Pub. No.: US 2023/0368207 A1
(43) Pub. Date: Nov. 16, 2023

(54) TRANSACTION RISK ASSESSMENT USING MACHINE-TRAINED MODELS

(71) Applicant: eBay Inc., San Jose, CA (US)

(72) Inventors: Shakul Hameed, San Jose, CA (US); Scott David Sharp, San Jose, CA (US); Om Prakash Kannusami, Milpitas, CA (US); Alagu Muthuraman, Los Altos, CA (US)

(21) Appl. No.: 17/745,791

(22) Filed: May 16, 2022

(51) Int. Cl. G06Q 20/40

(52) U.S. Cl. CPC G06Q 20/4016

(57) ABSTRACT

Systems and methods are directed to assessing risk and triggering a mitigation action prior to executing an offer based on a level of risk. Risk models are trained with data extracted from past transactions, whereby the risk models are configured to determine levels of risk for potential transactions. A request to make an offer on a listing representing an item is received. In response, the system identifies one or more account attributes associated with the user account and determines a level of risk by applying the one or more account attributes to one or more of the risk models. If the level of risk transgresses a threshold, the system triggers the automatic payment flow prior to executing the offer, which includes causing display of an information request user interface through which payment and shipping information is received. Responsive to receiving the payment and shipping information, the offer is executed.

### TECHNICAL FIELD

The subject matter disclosed herein generally relates to network transactions. Specifically, the present disclosure addresses systems and methods that use machine-trained models to assess risk for a transaction and automatically trigger a mitigation action prior to executing an offer of the transaction.

### BACKGROUND

Conventionally, auctions and best offers allow a buyer to potentially reserve an item from a seller far in advance of paying for the item. For example, an auction can take several days to end and a winning bidder (i.e., a potential buyer) may forget to return and pay for a winning bid or may later decide that they no longer want the item. In the meantime, the inventory is locked, and the seller cannot sell the item to another potential buyer for a set duration of time. Even if the seller can relist the item for sale, the seller has to duplicate efforts and potential sales opportunities may have been lost. Thus, a risky potential buyer can cause a multitude of problems in a network system.

### BRIEF DESCRIPTION OF THE DRAWINGS

FIG. 1 is a diagram illustrating an example network environment suitable for determining risk using machine learning and automatically triggering a payment flow prior to allowing a user account to make an offer based on a risk level.

FIG. 2 is a diagram illustrating components of an example transaction system.

FIG. 3 is a diagram illustrating components of an example machine learning system.

FIG. 4 is a flowchart illustrating operations of an example method for training a machine learning risk model.

FIG. 5 is a flowchart illustrating operations of an example method for processing an offer request.

FIG. 6 is a flowchart illustrating operations of an example method for processing a second offer request.

FIG. 7 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Systems and methods that machine-train (i.e., using machine-learning) a plurality of risk models that determine a level of risk for a potential buyer and apply the risk models to requests to make an offer from the potential buyer (e.g., an individual placing a bid or making a best offer) are discussed herein. A risky potential buyer or transaction can refer to a likelihood a payment method or transactional data is fraudulent or stolen or a likelihood the transaction will not be completed (e.g., paid for). If the level of risk (e.g., aggregation or assessment of risk scores from application of one or more risk models) exceeds a threshold (e.g., 60% probability that the transaction will not be completed), a mitigation action is triggered prior to executing the offer (e.g., posting a bid or presenting a best offer to a seller). In one case, the mitigation action comprises an automatic payment flow, which requires the potential buyer to provide payment information and/or shipping information. If the offer is executed and accepted, the payment information may be automatically used to complete the transaction and the item shipped based on the shipping information.

The machine learning involves training on data from past transaction histories. Accordingly, the transaction histories are accessed and various attributes extracted. The attributes (also referred to as “features”) can include transaction attributes such as whether past transactions were a paid transaction or a non-paid transaction, locations of the paid transactions and the non-paid transactions, prices of items for the paid transactions and the non-paid transactions, payment instruments used, and categories of the items involved in the paid transactions and the non-paid transactions. The attributes may also include attributes of items, buyers, and/or sellers of these past transactions. One or more machine learning risk models are then trained with training data comprising the extracted features.

Some risk models may determine a threshold that indicates a risky buyer or transaction and/or a range of scores that indicate how risky a potential buyer or transaction is. The threshold/ranges can be continuously modeled and learned (e.g., on a daily basis) based on new completed transactions. In some cases, the threshold is a configurable or machine-learned value based on, for example, markets, categories, and/or price. For example, US gold bullion may have a threshold of 25% whereas Canadian auto parts may have a threshold of 75%.

During runtime, attributes associated with a request to make an offer on an item of a listing are extracted. The attributes can include one or more account attributes associated with a user account (of a potential buyer), one or more item attributes associated with the item, and/or one or more seller attributes associated with a seller account (of a seller) publishing the listing. Subsequently, the extracted attributes are applied to one or more machine-trained risk models. Application to the risk models may result in risk score(s), which can be aggregated and analyzed to determine a level of risk for the specific combination of the item, the potential buyer, and the seller. Based on the level of risk transgressing a threshold (e.g., 55% or 0.55 probability score likely to be an incomplete or risky transaction), the automatic payment flow is triggered. Upon completion of the new transaction, the attributes of the new transaction may be used to retrain/refine one or more of the risk models.

Advantageously, example systems and methods provide security to sellers that a potential buyer that makes an offer with respect to an item of a listing will, if the offer is accepted, complete the transaction. Accordingly, the present disclosure provides technical solutions that accurately predict when a potential buyer may be risky and automatically trigger a payment flow if the potential buyer is deemed risky. The technical solution uses machine-learning to train one or more risk models that, at runtime, identifies risky potential buyers and, for example, requires the potential buyer to complete the payment flow or, alternatively, blocks the offer from executing (e.g., will not submit the offer to the seller for consideration). New completed transactions can be used to retrain/refine the risk models. Thus, levels of risks and risk thresholds can be continuously modeled, learned, and changed (e.g., on a daily or weekly basis).

Accordingly, the described techniques provide a number of specific improvements over prior systems. One such improvement is that risky potential buyers can be blocked from making an offer. This reduces network traffic and saves on bandwidth since the system does not need to process risky offers (e.g., update an auction listing, present offer to seller, facilitate communications between the seller and potential buyer). Another improvement is that an accepted offer that has gone through the payment flow can have the transaction automatically completed without any user intervention by either the potential buyer or seller. This too reduces network traffic and saves on bandwidth since further communications do not need to be facilitated. Further still, because non-paid transactions are reduced, relistings of items for sale are also reduced, saving on network traffic, bandwidth, and storage capacity (e.g., maintaining the relisting on a publication system).

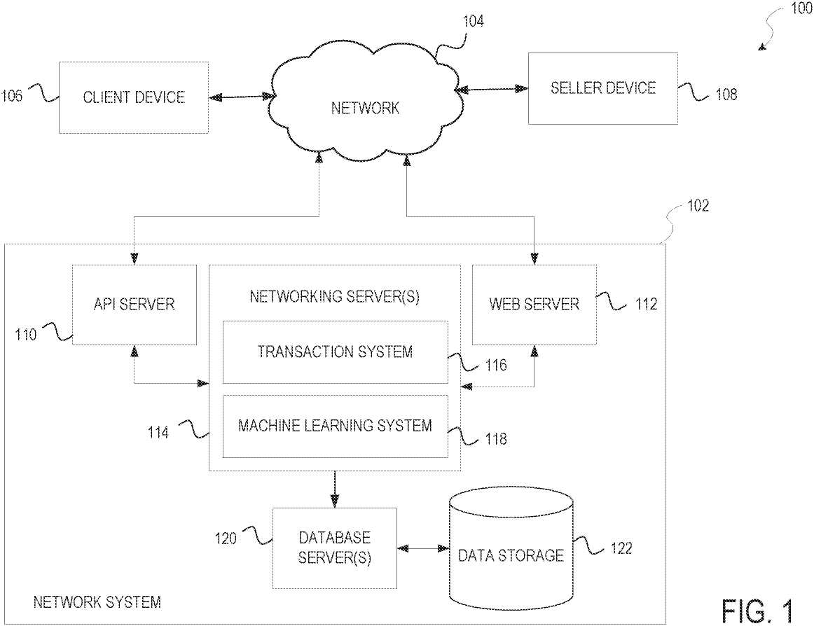

FIG. 1 is a diagram illustrating an example network environment 100 suitable for determining risk using machine learning and automatically triggering a payment flow prior to allowing a user to make an offer based on a determined risk. A network system 102 provides server-side functionality via a communication network 104 (e.g., the Internet, wireless network, cellular network, or a Wide Area Network (WAN)) to a client device 106 and a seller device 108. The network system 102 trains a plurality of risk models using transaction histories and, during runtime, applies the machine learning risk model (also referred to as machine-trained risk model) to a request to make an offer from a user account (of a potential buy) to determine a level of risk (e.g., a probability that a potential transaction and/or buyer is risky), as will be discussed in more detail below.

In various cases, the client device 106 is a device associated with the user account (e.g., the potential buyer) of the network system 102 that wants to make an offer for an item in a listing, while the seller device 108 is a device associated with a seller account (e.g., a seller of the item) of the network system 102. The seller account can publish the listing for the item via the network system 102 as will be discussed in more detail below.

The client device 106 and seller device 108 interface with the network system 102 via a connection with the network 104. Depending on the form of the client device 106 and seller device 108, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 includes a cellular network that has a plurality of cell sites of overlapping geographic coverage, interconnected by cellular telephone exchanges. These cellular telephone exchanges are coupled to a network backbone (e.g., the public switched telephone network (PSTN), a packet-switched data network, or other types of networks.

In another example, the connection to the network 104 is a Wireless Fidelity (Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

The client device 106 and seller device 108 may comprise, but are not limited to, a smartphone, tablet, laptop, multi-processor systems, microprocessor-based or programmable consumer electronics, game consoles, set-top boxes, a server, or any other communication device that can access the network system 102. The client device 106 and seller device 108 may comprise a display module (not shown) to display information (e.g., in the form of user interfaces). The client device 106 and/or the seller device 108 can be operated by a human user and/or a machine user.

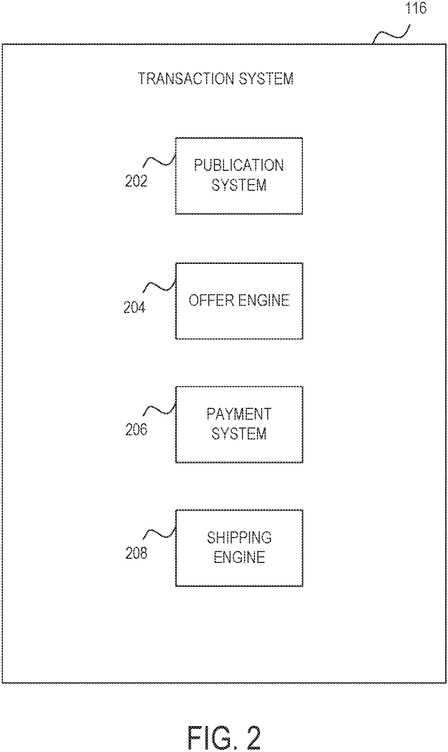

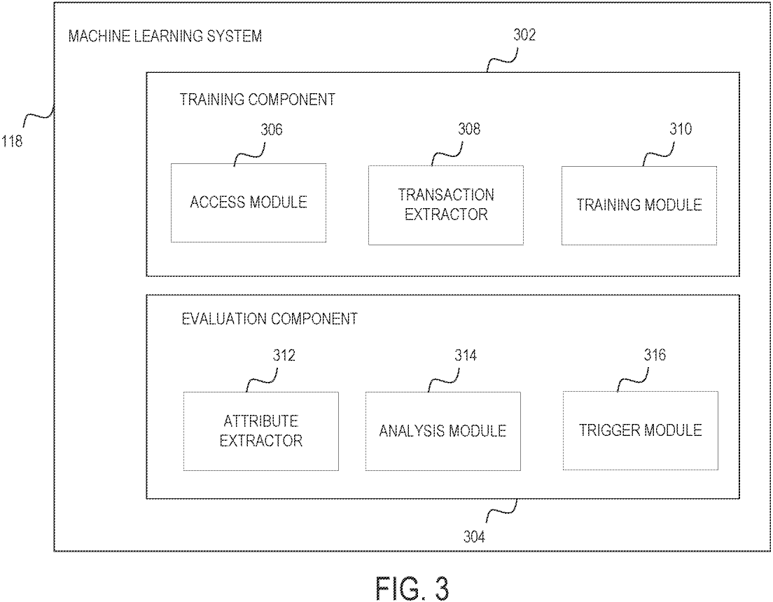

Turning specifically to the network system 102, an application programing interface (API) server 110 and a web server 112 are coupled to, and provide programmatic and web interfaces respectively to, one or more networking servers 114. The networking server(s) 114 host a transaction system 116 and a machine learning system 118, which comprises a plurality of components, and which can be embodied as hardware, software, firmware, or any combination thereof. The transaction system 116 will be discussed in more detail in connection with FIG. 2 and the machine learning system 118 will be discussed in more detail in connection with FIG. 3.

The networking servers 114 are, in turn, coupled to one or more database servers 120 that facilitate access to one or more storage repositories or data storage 122. The data storage 122 is a storage device storing transaction histories. Additionally or alternatively, the data storage 122 is a storage device that can store the machine-trained risk models.

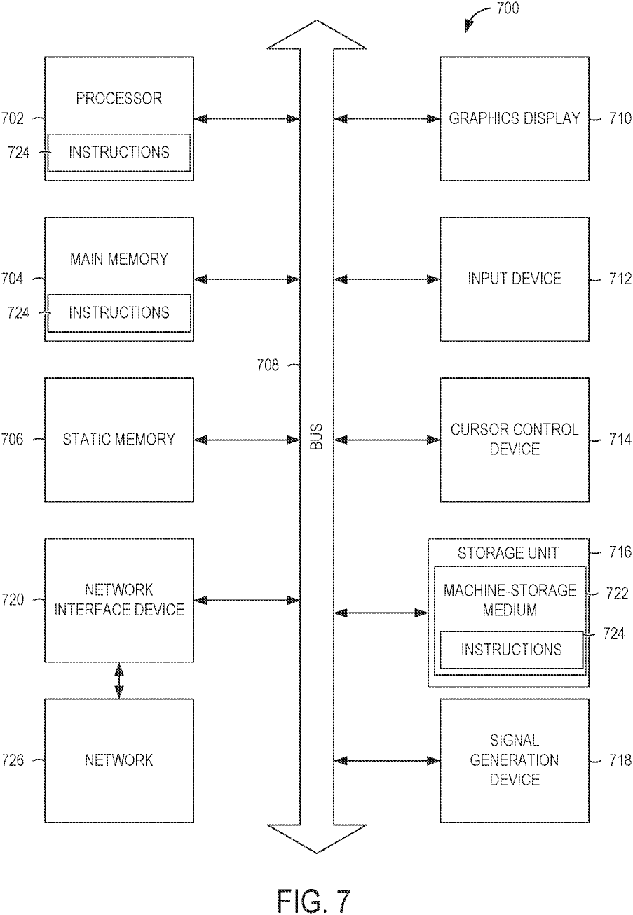

Any of the systems, servers, data storage, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other pi-ograiii) to perform one or more of the functions described herein for that system or machine. For example, a special-purpose computer system able to implement any one or more of the methodologies described herein is discussed below with respect to FIG. 7, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, some functionalities of the transaction system 116 may be embodied in the machine learning system 118 and/or vice-versa. Additionally, any number of client devices 106 and seller devices 108 may be embodied within the network environment 100. While only a single network system 102 is shown, alternatively, more than one network system 102 can be included (e.g., localized to a particular region).

FIG. 2 is a diagram illustrating components of the transaction system 116. The transaction system 116 is configured to manage listings and transactions at the network system 102 including publishing listings, processing offers and payment, and managing shipment of items. To enable these operations, the transaction system 116 comprises a publication system 202, an offer engine 204, a payment system 206, and a shipping engine 208 all configured to communicate with one another (e.g., via a bus, shared memory, or a switch). Alternative examples may comprise more or less components, combine the functions of some these components into a single component, or making some components optional.

The publication system 202 publishes listings on the network system 102. As such, the publication system 202 provides a number of publication functions and services to users (e.g., sellers) that access the networked system 102. For example, the publication system 202 can host a marketplace application that provides a number of marketplace functions and services to users, such as publishing, listing, and price-setting mechanisms whereby a seller may list (or publish information concerning) goods or services (also collectively referred to as “items”) for sale. It is noted that the publication system 202 may, alternatively or in addition, be associated with a non-marketplace environment such as an informational environment (e.g., search engine) and/or social networking environment.

The offer engine 204 manages offer requests and processing of offers. Initially, the offer engine 204 receives a request from a potential buyer (from a user account of the potential buyer) to make an offer on an item in a published listing. The request may include an identifier of the potential buyer (e.g., an identifier of the user account) and an indication of the item or listing that the offer pertains to. In some cases, the request also includes an offer amount. The offer amount can be a bid in an auction or a best offer amount, to name a few examples. When the offer engine 204 receives the request, the offer engine 204 triggers an analysis by the machine learning system 118. Based on the results of the analysis, the offer engine 204 can receive an indication to execute the offer without triggering a payment flow, receive an indication to trigger the payment flow prior to executing the offer, or, in some cases, receive an indication to block the offer made in the request. The machine learning system 118 will be discussed in more detail in connection with FIG. 3.

If the indication is to execute the offer without triggering the payment flow (e.g., a level of risk fails to transgress a risk threshold), the offer engine 204 executes the offer. In cases where the request includes the offer amount, the offer engine 204 provides the offer amount made in the request to the seller account for consideration for a best offer scenario. Alternatively, if the offer is a bid in an auction, the bid is posted in the auction. In cases where the request does not include an offer amount, the offer engine causes display of an offer user interface through which the potential buyer can provide one or more terms of the offer including the offer amount.

If the indication is to trigger the payment flow, then the offer engine 204 causes display of an information request user interface. The information request user interface requires the user to enter, into respective fields, payment information and shipping information, for instance. The payment information can include credit card information (e.g., number, billing address, expiration date) or payment account information (e.g., PayPal information, debit card information). In cases where the request does not include an offer amount, the information request user interface may also include a field for entering the offer amount. Alternatively, the offer engine can cause display of an offer user interface after information on the information request user interface is submitted.

In some cases, the risk level may be too high to allow the user to bid (e.g., risk level transgresses a higher risk threshold). For example, if the item is a unique item with a high current price (e.g., high bids pending) and the user has a history of not completing transactions or returning a large percentage of items, the risk level is extremely high and the offer engine 204 may block the user account from making an offer. In these cases, the offer engine 204 does not execute the offer (e.g., does not post a bid made for an auction or present a best offer to a seller account).

In cases where the executed offer is insufficient (e.g., the best offer is rejected by the seller or the bid is outbid), the offer engine 204 determines if the listing is still available. For example, the offer engine 204 may check with the publication system 202 whether there is still time remaining for an auction listing or whether a best offer listing has expired. If the listing is still available, the offer engine 204 provides a notification to the user account that the offer is insufficient and that the listing is still available. The user account can then submit a second offer request with a higher offer amount.

The second offer request may trigger another analysis by the machine learning system 118. For example, if the first request was executed without triggering the payment flow, the analysis is performed again to determine if the second request triggers the payment flow. In these cases, an item attribute (e.g., current price) or user attribute (e.g., number of completed and paid transactions, offer amount) may have changed significantly from when the first analysis was performed such that the payment flow may now be triggered. If the second request does not trigger the payment flow, then the second offer is executed. In cases where the first request triggers a payment flow based on transgressing a first threshold, the second analysis may be performed to determine if a verification process should be performed based on transgressing a second threshold (e.g., a higher threshold).

The payment system 206 manages payment information and processing of payments to complete the transaction. In cases where the payment flow is triggered, the payment information received by the offer engine 204 may be transmitted to the payment system 206, which can store the payment information (e.g., to the user account; associated it with the listing). In some cases, payment is automatically processed without the potential buyer completing checkout after an offer is accepted. In some instances, the potential buyer is allowed a predetermined amount of time to complete checkout before automatic payment is triggered. Thus, the payment system 206 may trigger a delay mode which causes a delay in automatic payment and shipping processing using the information received through the payment flow for the predetermined amount of time (e.g., a few days such as four days) to allow the user to manually complete the transaction by providing payment and confirming a shipping address. If the user does not complete the transaction after the predetermined amount of time, the payment system 206 automatically processes (or triggers a third-party payment service to process) the payment using the payment information received through the payment flow.

The shipping engine 208 manages shipping information and the shipping process. In cases where the payment flow is triggered, the shipping information received by the offer engine 204 may be transmitted to the shipping engine 208, which can store the shipping information. If the offer is eventually accepted, the delay mode is triggered. If the user does not complete the transaction after the predetermined amount of time, payment is processed by the payment system 206 and the shipping engine 208 uses the shipping information received through the payment flow to ship the item without user intervention (thus reducing network traffic and saving bandwidth by not requiring back-and-forth communications with the potential buyer or relisting by the seller).

In some examples, a first threshold that triggers the payment flow is a lower threshold value (e.g., first threshold is 55% or 0.55 probability score on a 0-1 scale) and a second threshold that is a higher threshold value (e.g., second threshold is 75% or 0.75 probability score) triggers a verification process. For example, if the level of risk transgresses both the first threshold and the second threshold, the payment flow is triggered (based on the first threshold) and the payment system 206 may perform an address verification process (based on the second threshold) using the address received through the payment flow (e.g., the billing address). If the address is verified, then the offer engine 204 executes the offer. In another example, if the level of risk transgresses both the first threshold and the second threshold, the payment flow is triggered and the payment system 206 may perform a credit verification process (based on the second threshold) using the payment information received through the payment flow (e.g., credit card verification). If the credit is verified, then the offer engine 204 executes the offer. Other verification processes can be used to verify an identity of the user. In some cases, the first request may trigger the payment flow based on the first request transgressing the first threshold and the second request may trigger the verification process based on the second request transgressing the second threshold.

FIG. 3 is a block diagram illustrating components of the machine learning system 118. The machine learning system 118 is configured to train a plurality of risk models. During runtime, the plurality of risk models are used to derive a level of risk that determines whether to perform a payment flow or verification process. The level of risk may, in some cases, be expressed as a risk score (or aggregated risk score if more than one risk model is used), which is compared to one or more thresholds (e.g., a first threshold to trigger the payment flow; a second threshold to trigger the verification process). To enable these operations, the machine learning system 118 includes a training component 302 and an evaluation component 304. While FIG. 3 shows the training component 302 and the evaluation component 304 being embodied within the machine learning system 118, alternatively, the training component 302 can be separate from the evaluation component 304 in a different system or server. For example, the evaluation component 304 may be a part of the transaction system 116.

The training component 302 trains a plurality of risk models using training data derived from past transactions that occurred via the network system 102 (e.g., facilitated by the transaction system 116). The machine learning can occur using linear regression, logistic regression, a decision tree, an artificial neural network, k-nearest neighbors, and/or k-means, to name a few examples. The training component 302 can comprise an access module 306, a transaction extractor 308, and a training module 310.

The training component 302 can train a plurality of risk models. In various cases, risk models may be associated with a different entity involved in a transaction. For example, a first risk model can be trained based on buyer attributes (e.g., user account attributes or features), a second risk model can be trained based on seller attributes (e.g., seller account attributes or features), and a third risk model can be trained based on item attributes or features. Additionally or alternatively, risk models can also be trained based on attributes from a combination of entities.

The access module 306 accesses a data storage (e.g., data storage 122) that stores past transactions of items. The access module 306 may identify and group past transactions, for example, based on item categories, locations of users or sellers, completed transactions, and/or incomplete transactions (e.g., transactions where the buyer did not pay). The access module 306 can thus select the types or groups of past transactions used to train the risk models. As such, the access module 306 operates as a filter to select the past transactions from which features will be extracted to train specific risk models (e.g., for a specific location, specific category, disputed transactions, incomplete transactions, specific range of prices). In some cases, the access module 306 does not filter the past transactions but merely uses past transactions in a particular time frame.

The transaction extractor 308 is configured to extract training data from the past transactions. For example, the transaction extractor 308 extracts item attributes, seller account attributes, and/or user account attributes including locations of items or user accounts, prices for past transactions, whether payment methods or transactional data were fraudulent, and whether the transactions were completed or not completed. For instance, the transaction extractor 308 can scan the past transactions and identify item attributes from item attribute fields and transaction locations from a location field. The extracted data is then passed to the training module 310.

The training module 310 trains the machine learning risk models using, for example, neural networks or classical machine learning. The training data used for training may include the item attributes, seller account attributes, and/or user account attributes (collectively referred to as “features”) for the past transactions. The training of the machine learning risk models may include training for probabilities (e.g., thresholds and/or ranges) of whether a buyer is a risky buyer (e.g., not paying for a transaction or completing the transaction) or a transaction will be a risky transaction. The machine training can occur using, for example, linear regression, logistic regression, a decision tree, an artificial neural network, k-nearest neighbors, and/or k-means.

During runtime, the evaluation component 304 of the machine learning system 118 is configured to determine a level of risk (e.g., a risk score or aggregated risk assessment) based on attributes associated with a potential transaction (e.g., based on an offer request) and to provide an indication of whether to trigger a payment flow or verification process. To perform these operations, the evaluation component 304 comprises an attribute extractor 312, an analysis module 314, and a trigger module 316.

During runtime, the offer engine 204 receives an offer request from a user account that indicates an item from a listing that the user account wants to make an offer on. The offer engine 204 may then trigger the evaluation component 304 to perform the analysis by providing the request or data from the request (e.g., listing identifier, user account identifier, seller identifier) to the evaluation component 304. The evaluation component 304 (e.g., the attribute extractor 312) can access the listing, user account information, and/or seller account information from the transaction system 116. For example, the attribute extractor 312 can access the listing and account information (e.g., account profiles) directly from the transaction system 116. The attribute extractor 312 then extracts item attributes of the item of the listing, seller account attributes for a selling account that listed the item, and/or user account attributes for a user account that is making the offer request.

For example, the attribute extractor 312 can access the account profile or account history associated with the user account and determine user account attributes such as, for example, user account location, a number of incomplete transactions (e.g., non-payment for previously accepted offers), a length of time the user account has been active on the network system 102, an average offer amount, a number of returns, a number of transactions completed, a frequency of transactions, an average completed transaction amount, and/or number of offer cancellations. The attribute extractor 312 may also identify an offer amount associated with the user account.

In another example, the attribute extractor 312 can access the account profile or account history associated with the seller account and determine seller account attributes such as, for example, a length of time or experience of the seller account with the network system 102 (e.g., seller tenure), a seller volume, a number of transactions per day or month, a dollar amount per transactions, a location (e.g., whether it is a shipping location or a drop ship location), and/or seller ranking and factors (e.g., fast shipper, items not received, cancellations). The seller ranking or factors can be used to indicate that the seller account is for a highly rated seller. In some cases, a highly rated seller may not have a corresponding risk level assessment performed.

Additionally, the attribute extractor 312 can access the listing associated with the item and determine item attributes such as, for example, a current price or price point, a reserve price, and/or category (e.g., is it a unique item or a trending category).

The extracted attributes are then passed to the analysis module 314, which applies one or more of the machine learning risk models to the extracted attributes. For example, user account attributes may be applied to one or more risk models trained on user account features, item attributes may be applied to one or more risk models trained on item features, and/or seller attributes may be applied to one or more risk models trained on seller features. Additionally or alternatively, any combination of user account attributes, item attributes, and/or seller account attributes can be applied to one or more risk models trained on a corresponding combination of features. In some cases, the risk models are based on different components such as, for example, categories, past purchases, past disputes, and so forth. In these cases, the risk models may be grouped for use case needs (e.g., offer US models; offer German models).

In some cases, the output of the risk model is a risk score that indicates a level of risk (e.g., probability that the buyer is risky, transactional data is fraudulent, or the transaction will not be completed). The risk score may be compared, by the trigger module 316, to a range of scores (referred to as “thresholds”) to determine if the risk score transgresses a threshold. In various cases, different risk models may be associated with different thresholds. For example, a user risk model or user risk score may be associated with one threshold (e.g., 55% or 0.55 probability score), while a seller risk model or seller risk score may be associated with a different threshold (e.g., 70% or 0.70 probability score).

More than one risk model may be used to determine the level of risk, which resulting in a plurality of risk scores that are output by the analysis module 314. In some cases, if any of the risk scores transgresses a corresponding threshold, then, based on the threshold transgressed (e.g., a first threshold, a second (higher) threshold), a payment flow or a verification process is triggered by the trigger module 316.

In other cases, if one of the risk scores transgresses a threshold, the trigger module 316 performs an assessment to determine whether to trigger a mitigation action (e.g., payment flow or verification process). In these cases, the trigger module 316 balances the outcome of the different risk models. For example, a first risk model may determine that the user account is associated with a risky user because the user account has a threshold percentage of cancelled transaction, incomplete transactions, and/or returns. However, a second risk model may determine that the seller has an extremely low risk score because, for example, the seller is experienced (e.g., more than 10 years), knows how to handle bad buyers, and is not as bothered by incomplete transactions. In this case, the triggering module 316 may weigh the risk score from the seller risk model(s) higher than the risk score from the user risk model(s) and determine that the offer from the user account may be executed without triggering the mitigating action. For example, weight coefficients can be used (e.g., 0.4 x [user risk score] + 0.6 x [seller risk score] = aggregated risk score). In various cases, the weights to be applied are machine-learned by risk models (e.g., based on transaction histories). In alternative cases, one or more priority-based rules may be used, whereby the priority-based rules indicate a priority order for the risk models/scores and/or weights to be applied. These priority-based rules may be machine-learned based on past transaction histories (e.g., by risk models).

In another example, if the user account has a high risk score based on the user account being relatively new to the network system 102 (e.g., user account only active for two weeks, user account only has one completed transaction), the payment flow may be triggered regardless of a seller risk score or item risk score (or the user risk score is weighted higher than the seller risk score in determining the level of risk). Alternatively, the offer may not be executed for a unique or expensive category unless the user account is a top user account (e.g., based on a user account rating or having a high number and/or percentage of completed transactions) or having a certain level of experience.

In another example, the item risk score may be high based on the item being in high demand (e.g., a baseball card trending in social media) or having a high current price (e.g., above $5000). In this example, a number of user accounts allowed to make an offer can be limited using the risk model(s). Thus, risky buyers may be blocked from making an offer or be automatically required to go through the payment flow regardless of the risk score associated with the user account. The trigger module 316, in these cases, can determine if the risk score or level of risk transgresses a lower threshold in its assessment in order to limit the number of user accounts allowed to make an offer.

In a further example, user accounts and/or seller accounts that are geolocated in a region (e.g., country, state) that is problematic can trigger blockage of execution of an offer or may trigger performance of the payment flow. A problematic region may include a region having a high percentage of incomplete transactions (e.g., triggering the payment flow) or a region that is prohibited from purchasing the item, for example, because of export control (e.g., rejecting execution of the offer). These regions can be identified using the machine trained risk models.

The triggering module 316 may also determine a type of mitigation action to use. For example, if a risk score is based on the item having a threshold high price (e.g., goes over $10,000), the mitigation action may include both the payment flow (to obtain credit card information and shipping information) and the verification process to verify the user has the funds (e.g., perform a credit check), verify an identity, and/or verify an address associated with the user account making the request. Other mitigating actions may be contemplated to “know the user” and confirm whether the user account be allowed to make an offer.

Thus, there may be risk models based on transactions (e.g., a price, uniqueness, category); risk models based on payment (e.g., by user, by location, by payment method); risk models based on buyers (e.g., buyer experience (e.g., number or percentage of completed transactions, tenure), ranking, or location); and so forth. And, the output of these risk models may be weighed, by the trigger module 316, against one another to determine whether to trigger the mitigation action and/or which mitigation action to trigger. In some cases, the trigger module 316 then provides an indication of the mitigation action to be performed to the transaction system 116 (e.g., the offer engine 204). Thus, the trigger module 316 may assess the output of the analysis module 314 (e.g., results of the risk model) to determine a level of risk, whether the level of risk transgresses a threshold, and what mitigation action to trigger.

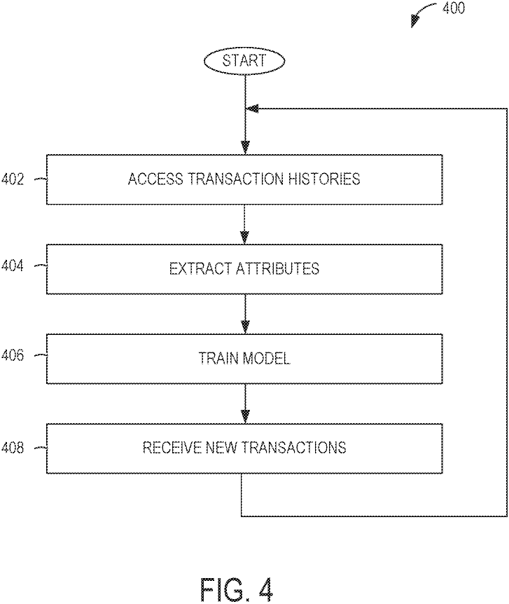

FIG. 4 is a flowchart illustrating operations of an example method 400 for training a machine-trained risk model. Operations in the method 400 may be performed by the machine learning system 118, using components described above with respect to FIG. 3. Accordingly, the method 400 is described by way of example with reference to the machine learning system 118. However, it shall be appreciated that at least some of the operations of the method 400 may be deployed on various other hardware configurations or be performed by similar components residing elsewhere in the network environment 100. Therefore, the method 400 is not intended to be limited to the machine learning system 118.

In operation 402, the machine learning system 118 accesses transaction histories. In some cases, the access module 306 accesses a data storage (e.g., data storage 122) that stores the transaction histories. Additionally, the access module 306 may identify and group/cluster past transactions, for example, based on item categories, locations of users or sellers, completed transactions, and/or incomplete transactions (e.g., transactions where the buyer did not pay). Thus, the training may be performed based on the grouping of the transactions by access module 306.

In operation 404, the transaction extractor 308 extracts features (e.g., training data) from the past transactions. For example, the transaction extractor 308 can extract item attributes, seller account attributes, and/or user account attributes including locations of items or user accounts, prices for past transactions and whether the transactions were completed or not completed. The extracted data is then passed to the training module 310.

In operation 406, one or more machine learning risk models are trained by the training module 310. In example cases, the extracted features from operation 404 are provided to the training module 310. The machine learning can occur using linear regression, logistic regression, a decision tree, an artificial neural network, k-nearest neighbors, and/or k-means. The training of the machine learning risk models may include calculating probabilities of whether/when a transaction or a buyer is risky (e.g., not paying for a transaction or completing the transaction), determining weight coefficients, and/or determining priority-based rules.

In operation 408, new transactions (both complete and incomplete transactions) are received as they are performed by the transaction system 116. The new transactions may be stored to the data storage and subsequently used to retrain/refine one or more of the risk models. Thus, operations 402 to 408 of the method 400 are periodically repeated.

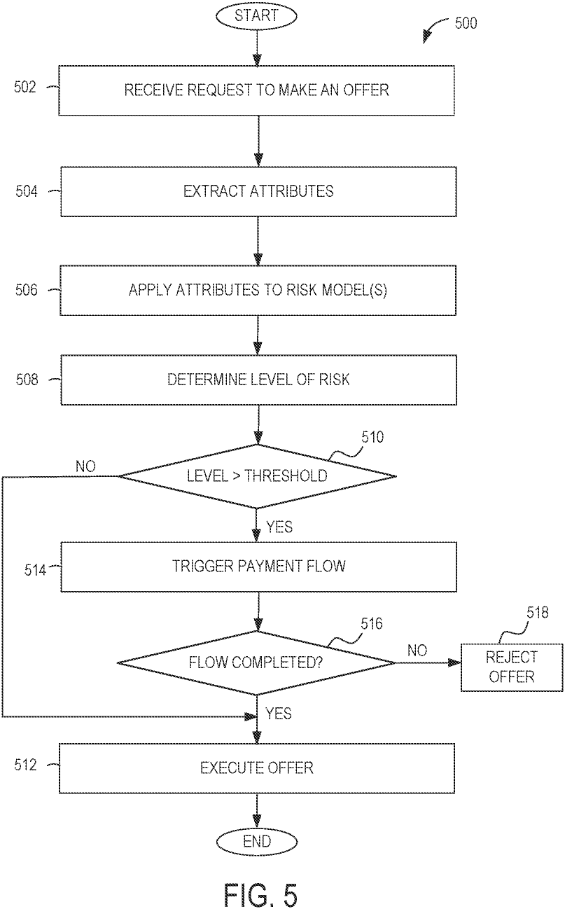

FIG. 5 is a flowchart illustrating operations of a method 500 for processing an offer request. Operations in the method 500 may be performed by the network system 102, using components described above with respect to FIG. 1 to FIG. 3. Accordingly, the method 500 is described by way of example with reference to the network system 102 (e.g., the transaction system 116 and the machine learning system 118). However, it shall be appreciated that at least some of the operations of the method 500 may be deployed on various other hardware configurations or be performed by similar components residing elsewhere in the network environment 100. Therefore, the method 500 is not intended to be limited to the network system 102.

In operation 502, the network system 102 (e.g., the offer engine 204) receives a request from a potential buyer (from a user account of the potential buyer) to make an offer for an item in a published listing. The request may include an identifier of the potential buyer (or user account) and an indication of the item or listing that the offer pertains to. In some cases, the request also includes an offer amount. The offer amount can be a bid in an auction or a best offer amount. When the offer engine 204 receives the request, the offer engine 204 triggers an analysis by the machine learning system 118 by providing the request or data from the request (e.g., listing identifier, user account identifier, seller identifier) to the evaluation component 304.

In operation 504, the attribute extractor 312 extracts attributes associated with the offer request. For example, the attribute extractor 312 can access the account profile or account history associated with the user account making the offer request and determine user account attributes such as, for example, user account location, a number of incomplete transactions, a length of time the user account has been active, an average offer amount, a number of returns, a number of transactions completed, a frequency of transactions, an average completed transaction amount, number of offer cancellations, and/or an offer amount of the offer request. The attribute extractor 312 can also access the account profile or account history associated with the seller account and determine seller account attributes. Additionally, the attribute extractor 312 can access the listing associated with the item and determine item attributes such as, for example, a current price or price point, a reserve price, and/or category.

In operation 506, the analysis module 314 applies the extracted attributes to one or more risk model(s). For example, user account attributes may be applied to one or more risk models trained on user account features (e.g., user risk model(s)), item attributes may be applied to one or more risk models trained on item features (e.g., item risk model(s)), and/or seller attributes may be applied to one or more risk models trained on seller features (e.g., seller risk model(s)). Additionally or alternatively, any combination of user account attributes, item attributes, and/or seller account attributes can be applied, by the analysis module 314, to one or more risk models trained on a corresponding combination of features.

In operation 508, the evaluation component 304 determines a level of risk. In some cases, the output of the risk model is a risk score or probability that indicates a level of risk (e.g., probability that the buyer is risky or the transaction will not be completed). In other cases, more than one risk model may be used in operation 506. This results in a plurality of risk scores or probabilities that are output by the analysis module 314. In some cases, the trigger module 316 performs an assessment based on the plurality of risk scores or probabilities, to determine an aggregated level of risk. In these cases, the trigger module 316 may apply different weights to the risk scores/probabilities obtained from the different risk models in aggregating the risk scores and determining the aggregated level of risk. Alternatively, the trigger module 316 can apply priority-based rules to determine the aggregated level of risk.

A determination is made, in operation 510, whether the level of risk transgresses a threshold. If the level of risk does not transgress the threshold in operation 510, then the offer engine 204 executes the offer in operation 512. In cases where the request includes the offer amount, the offer engine 204 provides the offer made in the request to the seller account for consideration in the case of a best offer. Alternatively, if the offer is a bid in an auction, the bid is posted in the auction. In cases where the request does not include an offer amount, the offer engine 204 causes display of an offer user interface through which the potential buyer can provide one or more terms of the offer including the offer amount. The terms of the offer are then posted or provided to the seller account.

However, if the level of risk does transgress the threshold in operation 5 10, then a payment flow is triggered in operation 514. Triggering the payment flow includes the offer engine 204 causing display of an information request user interface. The information request user interface requires the user to enter payment information and shipping information. The payment information can include credit card information (e.g., number, billing address, expiration date) or payment account information (e.g., PayPal information, debit card information). In cases where the request does not include an offer amount, the information request user interface may also include a field for entering the offer amount.

In some cases, the payment flow may include a verification process. For example, if the level of risk is extremely high, the verification process can be triggered. The verification process can be an address verification process using the address received through the payment flow (e.g., the billing address), a credit verification process using the payment information received through the payment flow (e.g., credit card verification), or an identity verification process to verify a user of the user account.

A further determination is made, in operation 516, whether the payment flow is completed. For instance, the offer engine 204 determines whether the fields of the information request user interface have been filled in completely. In some cases, the information that is provided may be verified (e.g., credit check, address verification).

If the payment flow is completed, then the offer is executed in operation 512. However, if the payment flow is not completed and/or the verification process inconclusive (or information is not verified), then the offer is rejected in operation 518.

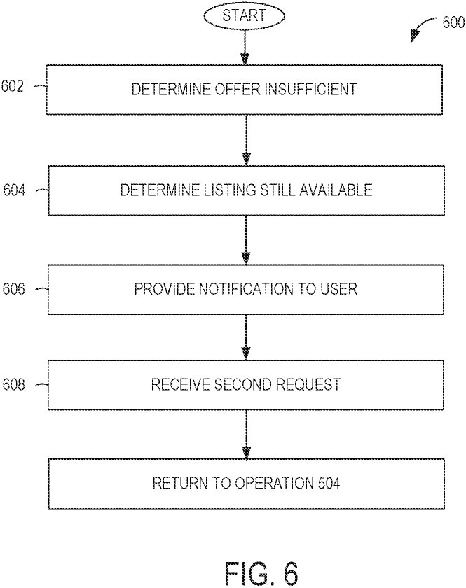

FIG. 6 is a flowchart illustrating operations of an example method 600 for processing a second offer. Operations in the method 600 may be performed by the network system 102, using components described above with respect to FIG. 1 to FIG. 3. Accordingly, the method 600 is described by way of example with reference to the network system 102 (e.g., the transaction system 116 and the machine learning system 118). However, it shall be appreciated that at least some of the operations of the method 600 may be deployed on various other hardware configurations or be performed by similar components residing elsewhere in the network environment 100. Therefore, the method 600 is not intended to be limited to the network system 102.

In operation 602, the transaction system 116 determines the offer is insufficient. For example, a best offer may be rejected by the seller or the bid amount is too low (e.g., a high bid has been received for the item).

In operation 604, the offer engine 204 determines whether the listing for the item is still available. For example, the offer engine 204 may check with the publication system 202 whether there is still time remaining for an auction listing or whether a best offer listing has expired.

Assuming the listing is still available, the offer engine 204 provides a notification to the user account that the offer is insufficient and that the listing is still available in operation 606. Based on the notification, the user account can then submit a second offer request with a higher offer amount. For instance, the notification can include a link that takes the user account back to the listing to provide the second offer request or the notification can include a link that takes the user account to an offer user interface where the user account can input the terms of the second offer request.

In operation 608, the offer engine 204 receives the second request. The second offer request may trigger another analysis by the machine learning system 118 by returning to operation 504.

FIG. 7 illustrates components of a machine 700, according to some examples that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIG. 4 to FIG. 6. In one example, the instructions 724 can transform the general, non-programmed machine 700 into a particular machine (e.g., specially configured machine) programmed to carry out the described and illustrated functions in the manner described.

In alternative examples, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with one another via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 may also reside, completely or at least partially, within the main memory 704, within the processor 702 (e.g., within the processor’s cache memory), or both, before or during execution thereof by the machine 700. Accordingly, the main memory 704 and the processor 702 may be considered as machine-readable media (e.g., tangible and non-transitory machine-readable media). The instructions 724 may be transmitted or received over a network 726 via the network interface device 720.

In some examples, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed examples.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magnetooptical disks; and CD-ROM and DVD-ROM disks. The terms machine-storage medium or media, computer-storage medium or media, and device-storage medium or media 722 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain examples are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various examples, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some examples, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering examples in which hardware modules are temporarily configured (e.g., programmed), the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In examples in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some examples, the one or more processors or processor-implemented modules may be located in a single geographic location (e.g., within a home environment, an office environment, or a server farm). In other examples, the one or more processors or processor-implemented modules may be distributed across a number of geographic locations.

### EXAMPLES

Example 1 is a method for assessing risk for a transaction to determine whether to automatically trigger a mitigation action prior to executing an offer of the transaction. The method comprises training, by a network system, a plurality of risk models with training data extracted from past transactions on the network system, the plurality of risk models configured to determine levels of risk for potential transactions; receiving, by the network system and from a user account, a request to make an offer on a listing representing an item; in response to receiving the request, identifying, by one or more hardware processors of the network system, one or more account attributes associated with the user account; determining a level of risk for a potential transaction involving the user account by applying the one or more account attributes to one or more of the plurality of risk models; responsive to determining that the level of risk transgresses a threshold, triggering the automatic payment flow prior to executing the offer, the automatic payment flow including causing display of an information request user interface through which payment information and shipping information is received; receiving the payment information and the shipping information from the user account; and responsive to receiving the payment information and the shipping information from the user account, executing the offer.

In example 2, the subject matter of example 1 can optionally include identifying one or more item attributes associated with the item, wherein the determining the level of risk for the potential transaction further comprises applying the one or more item attributes to the one or more of the plurality of risk models.

In example 3, the subject matter of any of examples 1 -2 can optionally include identifying one or more seller attributes associated with a seller account associated with the listing, wherein the determining the level of risk for the potential transaction further comprises applying the one or more seller attributes to the one or more of the plurality of risk models.

In example 4, the subject matter of any of examples 1-3 can optionally include, responsive to determining that the level of risk transgresses a second threshold, performing an address verification process prior to executing the offer.

In example 5, the subject matter of any of examples 1-4 can optionally include, responsive to determining that the level of risk transgresses a second threshold, performing a credit verification process prior to executing the offer.

In example 6, the subject matter of any of examples 1-5 can optionally include determining that the offer is insufficient for the user account to complete the potential transaction based on an offer price of the offer being lower than a current price or a reserve price; in response to determining that the offer is insufficient, determining that the listing is still available; in response to determining that the listing is still available, presenting a notification to the user account that the offer is insufficient and that the listing is still available; and in response to presenting the notification, receiving a second request from the user account to make a second offer on the listing representing the item, the second offer being different than the first offer.

In example 7, the subject matter of any of examples 1-6 can optionally include receiving an indication of acceptance of the offer; in response to the acceptance of the offer, triggering a delay mode of a payment system, the delay mode causing a delay in payment processing for a predetermined amount of time; and based on the predetermined amount of time passing without the user account tendering payment, automatically processing, by the network system, the payment using the payment information and the shipping information provided prior to the executing of the offer.

In example 8, the subject matter of any of examples 1-7 can optionally include wherein the training data extracted from the past transactions includes an indication of whether past transactions were a paid transaction or a non-paid transaction; locations of the paid transactions and the non-paid transactions; prices of items for the paid transactions and the non-paid transactions; or user account features, seller account features, or items features involved in the paid transactions and the non-paid transactions.

In example 9, the subject matter of any of examples 1-8 can optionally include wherein the one or more account attributes associated with the user account includes one or more of a length of time that the user account is activated with the network system, a number of completed paid transactions, a number of non-paid transactions, or a number of returns.

Example 10 is a method for assessing risk for a transaction to determine whether to automatically trigger a mitigation action prior to executing an offer of the transaction. The method comprises training, by a network system, a plurality of risk models with training data extracted from past transactions on the network system, the plurality of risk models configured to determine levels of risk for potential transactions; receiving, by the network system and from a user account, a request to make an offer on a listing representing an item; in response to receiving the request, identifying, by one or more hardware processors of the network system, one or more account attributes associated with the user account; determining a level of risk for a potential transaction involving the user account by applying the one or more account attributes to one or more of the plurality of risk models; and responsive to determining that the level of risk fails to transgress a threshold, executing the offer without triggering an automatic payment flow and processing one or more terms of the offer.

In example 11, the subject matter of example 10 can optionally include wherein the level of risk is a first level of risk, the method further comprising determining that the offer is insufficient for the user account to complete the potential transaction based on an offer price of the offer being lower than a current price; in response to determining that the offer is insufficient, determining that the listing is still available; in response to determining that the listing is still available, presenting a notification to the user account that the offer is insufficient and that the listing is still available; and in response to presenting the notification, receiving a second request to make a second offer on the listing representing the item, the second offer being different than the first offer.

In example 12, the subject matter of any of examples 10-11 can optionally include, in response to receiving the second request, determining a second level of risk prior to executing the second offer.

In example 13, the subject matter of any of examples 10-12 can optionally include, responsive to determining that the second level of risk transgresses the threshold, triggering the automatic payment flow prior to executing the second offer, the automatic payment flow including causing display of an information request user interface through which payment information and shipping information is received; receiving the payment information and the shipping information from the user account; and responsive to receiving the payment information and the shipping information from the user account, executing the second offer.

In example 14, the subject matter of any of examples 10-13 can optionally include, responsive to determining that the second level of risk fails to transgress the threshold, executing the second offer without triggering the automatic payment flow by causing display of the offer user interface and receiving one or more terms of the second offer.

Example 15 is a system comprising one or more hardware processors and a memory storing instructions that, when executed by the one or more hardware processors, cause the one or more hardware processors to perform operations for assessing risk for a transaction and determining whether to automatically trigger a mitigation action prior to executing an offer of the transaction. The operations comprise training, by a network system, a plurality of risk models with training data extracted from past transactions on the network system, the plurality of risk models configured to determine levels of risk for potential transactions; receiving, by the network system and from a user account, a request to make an offer on a listing representing an item; in response to receiving the request, identifying, by one or more hardware processors of the network system, one or more account attributes associated with the user account; determining a level of risk for a potential transaction involving the user account by applying the one or more account attributes to one or more of the plurality of risk models; responsive to determining that the level of risk transgresses a threshold, triggering the automatic payment flow prior to executing the offer, the automatic payment flow including causing display of an information request user interface through which payment information and shipping information is received; receiving the payment information and the shipping information from the user account; and responsive to receiving the payment information and the shipping information from the user account, executing the offer

In example 16, the subject matter of example 15 can optionally include wherein the operations further comprise identifying one or more item attributes associated with the item, wherein the determining the level of risk for the potential transaction further comprises applying the one or more item attributes to the one or more of the plurality of risk models.

In example 17, the subject matter of any of examples 15-16 can optionally include wherein the operations further comprise identifying one or more seller attributes associated with a seller account associated with the listing, wherein the determining the level of risk for the potential transaction further comprises applying the one or more seller attributes to the one or more of the plurality of risk models.

In example 18, the subject matter of any of examples 15-17 can optionally include wherein the operations further comprise responsive to determining that the level of risk transgresses a second threshold, performing an address verification process or a credit verification process prior to executing the offer.

In example 19, the subject matter of any of examples 15-18 can optionally include wherein the operations further comprise determining that the offer is insufficient for the user account to complete the potential transaction based on an offer price of the offer being lower than a current price or a reserve price; in response to determining that the offer is insufficient, determining that the listing is still available; in response to determining that the listing is still available, presenting a notification to the user account that the offer is insufficient and that the listing is still available; and in response to presenting the notification, receiving a second request from the user account to make a second offer on the listing representing the item, the second offer being different than the first offer.

In example 20, the subject matter of any of examples 15-19 can optionally include wherein the operations further comprise receiving an indication of acceptance of the offer; in response to the acceptance of the offer, triggering a delay mode of a payment system, the delay mode causing a delay in payment processing for a predetermined amount of time; and based on the predetermined amount of time passing without the user account tendering payment, automatically processing, by the network system, the payment using the payment information and the shipping information provided prior to the executing of the offer.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method for triggering an automatic payment flow, the method comprising:
training, by a network system, a plurality of risk models with training data extracted from past transactions on the network system, the plurality of risk models configured to determine levels of risk for potential transactions;
receiving, by the network system and from a user account, a request to make an offer on a listing representing an item;
in response to receiving the request, identifying, by one or more hardware processors of the network system, one or more account attributes associated with the user account;
determining a level of risk for a potential transaction involving the user account by applying the one or more account attributes to one or more of the plurality of risk models;
responsive to determining that the level of risk transgresses a threshold, triggering the automatic payment flow prior to executing the offer, the automatic payment flow including causing display of an information request user interface through which payment information and shipping information is received;
receiving the payment information and the shipping information from the user account; and
responsive to receiving the payment information and the shipping information from the user account, executing the offer.

2. The method of claim 1, further comprising:
identifying one or more item attributes associated with the item, wherein the determining the level of risk for the potential transaction further comprises applying the one or more item attributes to the one or more of the plurality of risk models.

3. The method of claim 1, further comprising:
identifying one or more seller attributes associated with a seller account associated with the listing, wherein the determining the level of risk for the potential transaction further comprises applying the one or more seller attributes to the one or more of the plurality of risk models.

4. The method of claim 1, further comprising:
responsive to determining that the level of risk transgresses a second threshold, performing an address verification process prior to executing the offer.

5. The method of claim 1, further comprising:
responsive to determining that the level of risk transgresses a second threshold, performing a credit verification process prior to executing the offer.

6. The method of claim 1, further comprising:
determining that the offer is insufficient for the user account to complete the potential transaction based on an offer price of the offer being lower than a current price or a reserve price;
in response to determining that the offer is insufficient, determining that the listing is still available;
in response to determining that the listing is still available, presenting a notification to the user account that the offer is insufficient and that the listing is still available; and
in response to presenting the notification, receiving a second request from the user account to make a second offer on the listing representing the item, the second offer being different than the first offer.

7. The method of claim 1, further comprising:
receiving an indication of acceptance of the offer;
in response to the acceptance of the offer, triggering a delay mode of a payment system, the delay mode causing a delay in payment processing for a predetermined amount of time; and
based on the predetermined amount of time passing without the user account tendering payment, automatically processing, by the network system, the payment using the payment information and the shipping information provided prior to the executing of the offer.

8. The method of claim 1, wherein the training data extracted from the past transactions includes:
an indication of whether past transactions were a paid transaction or a non-paid transaction,
locations of the paid transactions and the non-paid transactions;
prices of items for the paid transactions and the non-paid transactions; or
user account features, seller account features, or items features involved in the paid transactions and the non-paid transactions.

9. The method of claim 1, wherein the one or more account attributes associated with the user account includes one or more of:
a length of time that the user account is activated with the network system,
a number of completed paid transactions,
a number of non-paid transactions, or
a number of returns.

10. A method comprising:
training, by a network system, a plurality of risk models with training data extracted from past transactions on the network system, the plurality of risk models configured to determine levels of risk for potential transactions;
receiving, by the network system and from a user account, a request to make an offer on a listing representing an item;
in response to receiving the request, identifying, by one or more hardware processors of the network system, one or more account attributes associated with the user account;
determining a level of risk for a potential transaction involving the user account by applying the one or more account attributes to one or more of the plurality of risk models; and
responsive to determining that the level of risk fails to transgress a threshold, executing the offer without triggering an automatic payment flow and processing one or more terms of the offer.

11. The method of claim 10, wherein the level of risk is a first level of risk, the method further comprising:
determining that the offer is insufficient for the user account to complete the potential transaction based on an offer price of the offer being lower than a current price;
in response to determining that the offer is insufficient, determining that the listing is still available;
in response to determining that the listing is still available, presenting a notification to the user account that the offer is insufficient and that the listing is still available; and
in response to presenting the notification, receiving a second request to make a second offer on the listing representing the item, the second offer being different than the first offer.

12. The method of claim 11, further comprising:
in response to receiving the second request, determining a second level of risk for the potential transaction prior to executing the second offer.

13. The method of claim 12, further comprising:
responsive to determining that the second level of risk transgresses the threshold, triggering the automatic payment flow prior to executing the second offer, the automatic payment flow including causing display of an information request user interface through which payment information and shipping information is received;
receiving the payment information and the shipping information from the user account; and
responsive to receiving the payment information and the shipping information from the user account, executing the second offer.

14. The method of claim 12, further comprising:
responsive to determining that the second level of risk fails to transgress the threshold, executing the second offer without triggering the automatic payment flow by causing display of the offer user interface and receiving one or more terms of the second offer.

15. A system comprising:
one or more hardware processors; and
a memory storing instructions that, when executed by the one or more hardware processors, cause the one or more hardware processors to perform operations comprising:
training, by a network system, a plurality of risk models with training data extracted from past transactions on the network system, the plurality of risk models configured to determine levels of risk for potential transactions;
receiving, by the network system and from a user account, a request to make an offer on a listing representing an item;
in response to receiving the request, identifying, by one or more hardware processors of the network system, one or more account attributes associated with the user account;
determining a level of risk for a potential transaction involving the user account by applying the one or more account attributes to one or more of the plurality of risk models;
responsive to determining that the level of risk transgresses a threshold, triggering the automatic payment flow prior to executing the offer, the automatic payment flow including causing display of an information request user interface through which payment information and shipping information is received;
receiving the payment information and the shipping information from the user account; and
responsive to receiving the payment information and the shipping information from the user account, executing the offer.

16. The system of claim 15, wherein the operations further comprise:
identifying one or more item attributes associated with the item, wherein the determining the level of risk for the potential transaction further comprises applying the one or more item attributes to the one or more of the plurality of risk models.

17. The system of claim 15, wherein the operations further comprise:
identifying one or more seller attributes associated with a seller account associated with the listing, wherein the determining the level of risk for the potential transaction further comprises applying the one or more seller attributes to the one or more of the plurality of risk models.

18. The system of claim 15, wherein the operations further comprise:
responsive to determining that the level of risk transgresses a second threshold, performing an address verification process or a credit verification process prior to executing the offer.

19. The system of claim 15, wherein the operations further comprise:
determining that the offer is insufficient for the user account to complete the potential transaction based on an offer price of the offer being lower than a current price or a reserve price;
in response to determining that the offer is insufficient, determining that the listing is still available;
in response to determining that the listing is still available, presenting a notification to the user account that the offer is insufficient and that the listing is still available; and
in response to presenting the notification, receiving a second request from the user account to make a second offer on the listing representing the item, the second offer being different than the first offer.

20. The system of claim 15, wherein the operations further comprise:
receiving an indication of acceptance of the offer;
in response to the acceptance of the offer, triggering a delay mode of a payment system, the delay mode causing a delay in payment processing for a predetermined amount of time; and
based on the predetermined amount of time passing without the user account tendering payment, automatically processing, by the network system, the payment using the payment information and the shipping information provided prior to the executing of the offer.
